(19) United States
(12) Patent Application Publication
(10) Pub. No.: US 2015/0355787 A1
(43) Pub. Date: Dec. 10, 2015

(54) DYNAMICALLY EXECUTING MULTI-DEVICE COMMANDS ON A DISTRIBUTED CONTROL

(71) Applicant: YOKOGAWA ELECTRIC CORPORATION, Tokyo (JP)

(72) Inventor: Patrick CLAY, Frisco, TX (US)

(73) Assignee: YOKOGAWA ELECTRIC CORPORATION, Tokyo (JP)

(21) Appl. No.: 14/297,945

(22) Filed: Jun. 6, 2014

(51) Int. Cl. G06F 3/0482; G06F 3/0481; G06F 3/0484

(52) U.S. Cl. CPC G06F 3/0482; G06F 3/04842; G06F 3/04817

(57) ABSTRACT

A system and method for sending of data to a specified device without needing to preprogram a dedicated key of a human interface device. One embodiment provides for selection of a display where the display does not need to be programmed ahead of time. A user interface (UI) which allows the user to select the display is arranged in a similar configuration as the configuration of the physical display. In some embodiments, a method using another human interface device may be used. One embodiment may include the sending of data to a server, or first device, by means of a companion device, or second device. One embodiment provides for the sending of data to specific output devices for printing or manufacturing.

### BACKGROUND

1. Field

Exemplary embodiments relate to a control system, control software, user interfaces, methods of controlling multiple devices, and industrial automation processes.

2. Background

In the related art, the execution of a command or function can be achieved by use of one or a combination of plural dedicated keys that are preprogrammed to execute the command or function on a specific connected device. In the related art, a connected device is specified as part of the preprogramming process, and a key or combination of keys is dedicated to a specified connected device.

For example, within Industrial Automation (IA), there are control room environments for monitoring and controlling the industrial automation process. In the control room environment, there may be at least one human interface station (HIS) server or console. Conventionally, the primary human machine interface (HMI) interaction device for the console used by an operator is a wired, dedicated Operator keyboard. An exemplary dedicated Operator keyboard has hardware inputs, including normal QWERTY keyboard keys and dedicated keys that are preprogrammed to execute particular functions.

The dedicated Operator keyboard may be structured to provide function keys to control predetermined functions on a specific one of plural displays through preprogrammed settings. In the related art, navigation and operation of the multiple displays for a console can be controlled by the one dedicated Operator keyboard.

In current implementations of a control system using distributed control software, an Operator keyboard that is a hardware keyboard is necessary to input commands that when executed by a processor in a control system generate results that are displayed as display information on a display. These commands must be programmed in the control system ahead of time and pre-assigned to specific keys on the hardware keyboard.

FIG. 1A shows a related art device system 10 with a wired 16, dedicated Operator keyboard 14 for use with a console server 13 having a plurality of displays 12A-12D. In the related art, the hardware Operator keyboard 14 has fixed programmable function keys 15A, 15B, 15N for execution of a command or function preprogrammed for a specified display.

In a control room environment for a system that contains multiple displays, the processor in the system is programmed to execute commands and present the result of that execution on a specific display. Typically a display is assigned a number, and the command is appended with this number so that when the command is executed, the corresponding display number is matched up with the physical display. For example, with reference to FIG. 1B, a function key X must be preprogrammed to execute a command Y and present the results on display monitor Z 16. Thus, when a function key X is pressed, the command Y is executed and the resulting information is presented on the specified display Z 17. FIG. 1C illustrates a computer processing system having a console server with a processor 131, memory/storage 132, input/output (I/O) device 133, displays 134A, 134B and the like, as would be known in the art.

### SUMMARY

In the related art, the display to which the results of an executed command is to be sent must be known in advance and explicitly programmed to have a relationship with one or more keys of the Operational keyboard. The programmer responsible for creating these commands is burdened with understanding the relationship between a particular physical display in relation to its assigned number. Furthermore, when a physical display is added to or removed from a control system, the commands that contain relevant display number designations must be reprogrammed.

Accordingly, one or more disclosed embodiments of the improved display selection technology described herein are not programmed ahead of time. The command is display agnostic. The user chooses the display for the command at run-time of the command. Additionally, a user interface (UI), which allows the operator to select a display, is arranged in a configuration that is similar to the configuration of the physical display. This UI also provides the operator a valuable perspective for selecting a proper display as well as a sense of confidence in being able to select the correct display.

One or more of the disclosed embodiments are effective to simplify or expedite a user's ability to execute functions or commands on specific devices in a multi-device system.

One or more embodiments of the disclosure relate to the sending of data to a specified device without needing to preprogram a dedicated key of a human interface device. In some embodiments, a method using a touchscreen display may be employed to configure the system for the sending of data to a specified device. In some embodiments, a method using another human interface device may be employed. One embodiment includes the sending of data to a server, or first device, by means of a companion device, or second device. One embodiment includes the sending of data to a first device by a second device through a peer-to-peer session framework. Another embodiment includes the sending of data to devices linked in a network. A further embodiment includes the sending of data from virtual machines. Yet another embodiment includes the sending of data to a cloud or an external system or device from a device, system, or network.

According to one embodiment, a UI is provided for a control system where, after selecting a command or function, a representation of a layout of connected devices is displayed, such that a user can then select one of the devices from the representation as a targeted, specified device for receiving of data from the control system. In some embodiments, the selection of one of the devices can be done through a touchscreen display.

In some embodiments, the connected devices may be displays and the data being sent may be for displaying information on a specified display. For example, the control system may execute a command or function and then display the result of such execution on a selected display.

Alternatively, the connected devices may be output devices. In such case, this may provide for the sending of data for printing or manufacturing. The command or function may be data for controlling manufacturing processes and the output devices may include a manufacturing device, such as a computer numerical control (CNC) machine. Data to begin production of a product may be sent to a specified CNC machine through the UI. The output devices may include a printer, such that information can be sent to a specified printer.

Further, the connected devices may be storage devices. In such case, a user may select a command or function such that data is sent to a specified storage device. In one embodiment, the user may specify that a function or program be executed and the results saved in a specified storage device.

In some embodiments, the connected devices may be servers, workstations, or virtual machines. The user may be able to send commands to implement updates or execute commands on the connected devices.

In one embodiment, the representation of the layout of connected devices is a grouping of displays, as they are physically arranged. In one embodiment, there are clusters or groupings of displays. An example of where clusters or groupings may occur is when the control system is connected to multiple servers, each server being connected to an arrangement of displays.

In one embodiment, the representation of the layout of connected devices may show relative placement of the devices to one another as perceived from an overhead view of where the devices are located. The orientation of the overhead view may be oriented at least according to a cardinal direction, preprogramming, or another orientation as selected by a user. In addition, the representation of the layout of connected devices may be overlaid on a map to indicate placement in a location.

In one embodiment, the representation of the layout of connected devices may show relative placement of the devices to one another as perceived from a bird's eye view.

In one embodiment, the UI may be used with a mobile device, and further, the sensors of the mobile device may be used to provide additional functionality. The mobile device may have positional sensors, such as GPS or a gyroscope. Further, the representation of the layout of connected devices may be oriented based on the position and orientation information of the mobile device.

In some embodiments, the UI may indicate that a connected device is unsuitable for the user's function or command. The indication may include greying out of a representative icon of the device, a textual notification, or the like. The indication may be paired with an auditory sound to indicate a specific device is unsuitable if the user attempts to select it. A device may be unsuitable for various reasons. One example is where a display has a resolution too low to properly display the data. Another example, where the connected devices include a printer, is where the user desires to print data that is formatted for a different paper size than a printer carries. Another example is where the user desires to print in color when a printer is black and white. One example, where the connected devices include a storage device, is where a specific storage device does not have sufficient memory to properly execute the command or function.

The representation of the layout of connected devices may include different types of devices, including displays, printers, storage devices, and the like. In one embodiment, the UI may indicate that each of a type of device is unsuitable.

One embodiment provides for a method for sending data to a connected device in a device system having at least two connected devices, the device system having a graphical, interactive user interface with operation objects. The method includes displaying the user interface on an input display, selecting a function key from a first menu of the user interface in accordance with movement of a user, the first menu of the user interface having at least one function key, selecting a specified connected device from a second menu of the user interface in accordance with movement of a user, the second menu of the user interface having a representative layout of the connected devices indicating relative physical placements of the connected devices, and sending data related to the function key to the specified connected device.

The method may further include wirelessly connecting an input device to the device system, the input device being used as an input display for the user interface.

The method may further include displaying at least a portion of the data sent to the specified connected device, the data being related to the function key for the specified connected device, when the specified connected device is a display.

The method may further include executing a process based on the data sent to the specified connected device.

The method may further include printing based on the data sent to the specified connected device where the connected device is a printer.

The method may further include storing the data sent to the specified connected device where the connected device is a storage device.

The method may further include, wherein the second menu of the user interface has a representative layout of the connected devices indicating relative physical placements of the connected devices, a display of the layout as seen from an overhead view.

The method may further include, wherein the second menu of the user interface has a representative layout of the connected devices indicating relative physical placements of the connected devices, a display of the layout as seen from a bird's eye view.

The method may further include, wherein the second menu of the user interface has a representative layout of the connected devices indicating relative physical placements of the connected devices, a capability for the displayed devices to be toggled and maintained on the user interface.

The method may further include, wherein the second menu, when maintained on the user interface, a capability to transfer data sent to the connected device to a second connected device by a swiping movement from an icon representing the connected device to an icon representing the second connected device.

The method may further include a capability for the second menu to display readiness information regarding each connected device.

Another embodiment provides for a device system having a graphical, interactive user interface with operation objects for sending data to a connected device, including an input display, the input display displaying the user interface, and at least two connected devices, wherein the user interface has a first menu for selecting a function key in accordance with movement of a user, the first menu of the user interface having at least one function key, wherein after selecting a function key on the first menu of the user interface, the user interface has a second menu for selecting a specified connected device from the at least two connected devices in accordance with movement of a user, the second menu of the user interface having a representative layout of the connected devices indicating relative physical placements of the connected devices, and wherein the device system then sends data related to the function key to the specified connected device.

The device may further include wherein the input device is a mobile device wirelessly connected to the device system.

The device may further include wherein the connected device is a display and display at least a portion of the data sent relating to the function key.

### BRIEF DESCRIPTION OF THE DRAWINGS

FIG. 1A illustrates a related art monitor system with a dedicated Operator keyboard and function key, and FIG. 1B illustrates a flowchart for controlling the monitors with the keyboard. FIG. 1C illustrates a computer processing system having a console server with a processor, memory/storage, input/output (I/O) device, at least one display and the like, as would be known in the art.

FIG. 2 illustrates an exemplary console and display layout in a disclosed embodiment.

FIGS. 3A-3C illustrate screens of an exemplary input device and user interface according to a disclosed embodiment.

FIG. 4 illustrates an exemplary flow diagram illustrating the selection of a function and display according to a disclosed embodiment.

FIG. 5 illustrates an exemplary device and user interface illustrating the selection of a connected display according to a disclosed embodiment.

FIGS. 6A and 6B illustrate an exemplary device and user interface illustrating the selection of frames of a display according to alternative disclosed embodiments.

FIG. 7 illustrates an exemplary system of connected devices.

FIGS. 8A-8C illustrate screens of a user interface illustrating the selection of a connected device in a grouping according to an embodiment.

FIG. 9 illustrates a user interface illustrating groupings of connected devices and the selection of a connected device from one of the groupings according to an embodiment.

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein, and equivalent modifications. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

The term “display” used in the description is intended to describe embodiments with visual display methods, and is by no means restrictive. Exemplary displays may also include projectors or projection technology.

The term “function” used in the description is intended to describe embodiments with a data or command. Function is not limited to an algorithm or specific coding. Exemplary “function keys” may merely denote shortcuts or look ups to data or objects stored on a console server.

### Multi-Monitor Display Embodiments

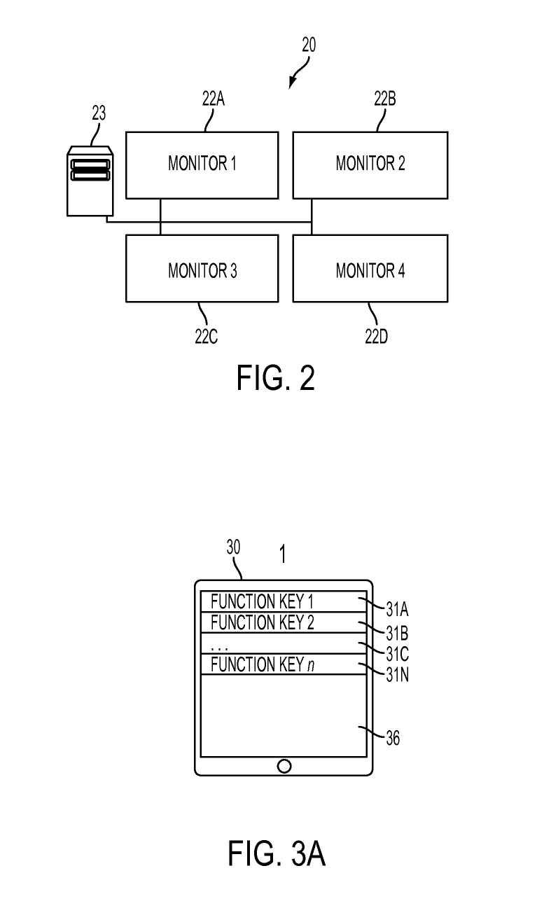

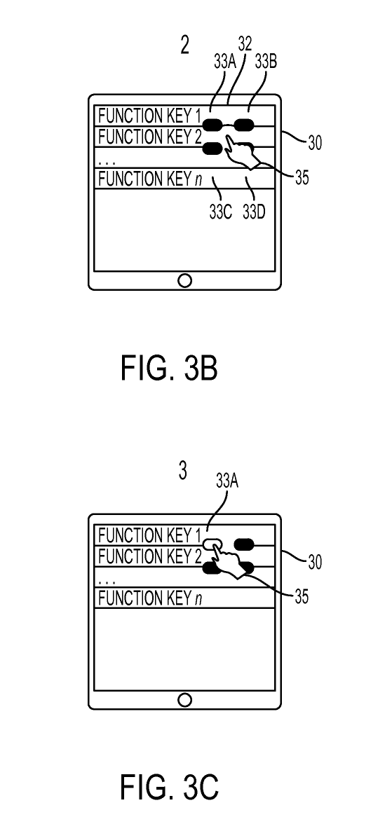

FIG. 2 shows an embodiment with a system 20 having a console server 23 with multiple displays 22A-22D. FIGS. 3A-3C show an input device 30, connected to the console server 23, which displays a UI 36 on an input display.

In embodiments of the disclosure, the UI 36 has operation objects, or representative icons, indicating computing instructions or designations. On a first menu, as illustrated in FIG. 3A, the UI 36 provides preprogrammed icons as function keys 31A-31C, 31N. The function keys 31A-31C, 31N may be laid out such that they are separated by bars to clearly show where each function key is on the UI 36. The UI 36 also includes a second menu, or submenu, as illustrated in FIG. 3B, which includes a representation of the displays layout 32 with representative icons 33A-33D. The user may then select 35 a specific display from the representation of the displays layout 32. As illustrated in FIG. 3C, selection of a function key from the UI results in the option to select a specific display from the representation of the representation of the displays layout 32.

In the related art, a keyboard button must be preprogrammed with both a function and a display. Thus, a programmer must be responsible for creating these commands by understanding the relationship between a physical display in relation to its assigned number during programming of the function keys. Furthermore, this is troublesome when a display is added or removed to a system, as the commands that contain display number designations must be reprogrammed.

In an embodiment illustrated in FIGS. 2 and 3A-3C, a connection is first established between the input device 30 and the console server 23. Then, the console server 23 sends information about the multiple displays 22A-22D to the input device 30. This information may include at least a number of displays, the shape or physical layout of the displays, or a mapping of each display's number as configured by the server.

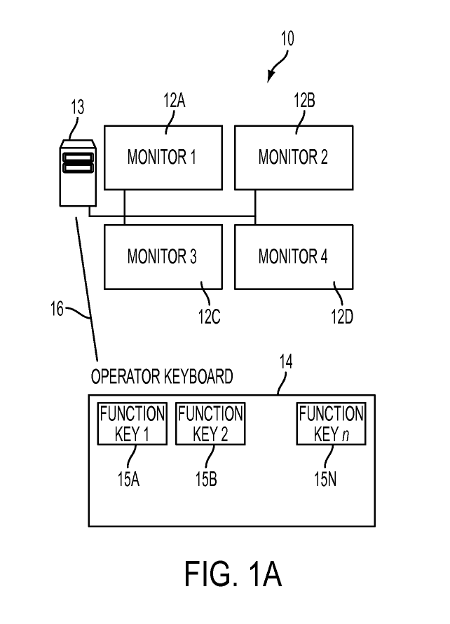

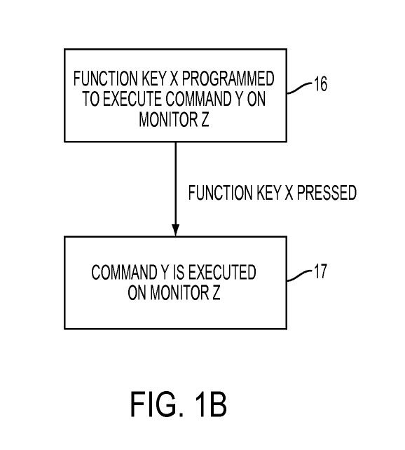

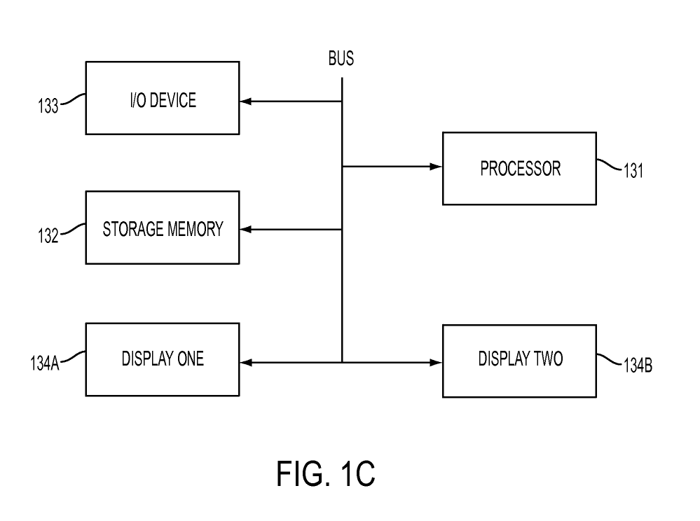

The information about the multiple displays may be from an operating system of the console server. The information about the multiple displays may be from a file or database stored on the console server in a system of the type illustrated in FIG. 1C. The information about the multiple displays may be manually stored.

In operation, with reference to FIGS. 3A-3C, a user can perform a tap and hold gesture on the input device for a desired function key 31. Following the tap and hold gesture, the UI 36 on the input device then shows a representation of the displays layout 32, as shown in FIG. 3B. The second menu may be overlaid on top of the first menu or replace the first menu. The representation of the displays layout 32 shows representative icons 33A-33D corresponding to the physical layout of the displays 22A-22D. The user can then drag a pointing device 35 or pointer to the desired display from the representative icons 33A-33D from the layout 32 and release the hold, as shown in FIG. 3C with the exemplary selection of icon 33A corresponding to display 22A. The input device then maps the user desired display from the representative layout, maps the function to the correct display, and sends the function key command and desired display to the console server. The console server can then execute the function or command on the desired display.

Alternatively, a user may use a tap and release gesture to select a desired function key and a second tap and release gesture to select a desired display.

In one embodiment, the input device may be a mobile device. Non-limiting examples of the mobile device, or input device, may include cellular phones, tablets, phablets, laptops, personal digital assistants, and the like.

The console server and input device may be connected by a wired connection or a wireless connection. The connection need not be direct. Non-limiting examples, either direct or wireless, for the connection include direct, through a network, or through daisy chaining. Non-limiting examples of a direct wireless connection include wireless peer-to-peer protocols such as [BLUETOOTH], [WI-FI DIRECT], [NFC], or the like.

In one embodiment, the input device has a touchscreen display and can be configured to display the UI.

However, the method of input for the embodiments is not limited to touch. Embodiments could be implemented using a mouse, stylus, or any other method of selecting a display using the custom display selection user interface.

In an alternative embodiment, the input device may send the input display data as to which representative display was selected, directly to the server, and the server may map the function to the correct display.

In an alternative embodiment, alternative gestures other than a tap and hold may be used. For example, a double tap gesture may be used to bring up the display layout.

Additionally, in an alternative embodiment to the illustration in FIG. 3B, the representation of the displays layout 32 can be used in other scenarios besides immediately executing a command via the tap-and-hold gesture. In one embodiment, the representation of the displays layout 32 can be brought up as a toggle button. The display selection would always be displayed on the input device and the currently toggled display would always be displayed as selected. All commands sent from the input device would be sent to the selected display until a change in selection is made.

In some embodiments, gestures can be used across the display icons in the representation of the displays layout 32. For instance, displaying the representation of the displays layout 32 for an extended period of time, or at all times, could allow for a user to move content between screens by performing a swipe gesture between two displays. The effect would be the contents of one display are swapped for the other.

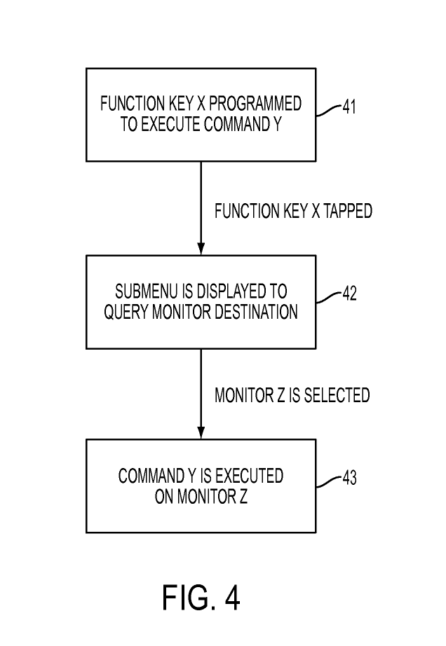

FIG. 4 shows an exemplary flow diagram illustrating the selection of a function and display with an input device. In a first step (step 41), function key X is programmed to execute command Y. However, programming of a function key does not require selection of a specific display. Instead, the function key is independent of the displays and brings up the representation of the displays layout 42. In a second step (step 42), a submenu is displayed to query a monitor designation. The user then chooses the desired display for the function. Finally, in a third step (step 43), the command is executed and the results displayed on the specified display identified in step 42.

### Additional Multi-Monitor Display Embodiments

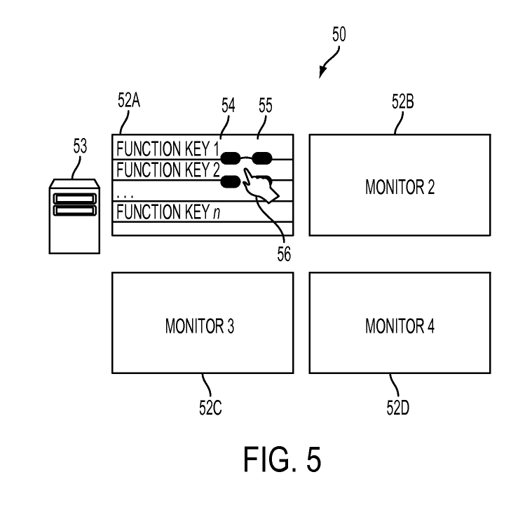

FIG. 5 shows an embodiment where the console system 50 may be only one server 53 having multiple displays 52A-52D. In some embodiments, the device may display the UI on one of the multiple displays, for example display 52A. In a first step, a user can perform a tap and hold gesture on the UI presented on display 52A for presentation of a desired function key 54. Following the tap and hold gesture, the UI on the input device then shows a representation of the displays layout 55. The user 56 can then drag the pointing device or pointer to the desired display from the layout and release contact. The input device maps the user desired display from the representative layout and maps the function to the correct display, and sends the function key command and desired display to the console server. The console server can then execute the function or command on the desired display.

Preferably, at least one of the multiple displays is a touchscreen display and can be configured to display the UI.

However, the method of input for the embodiments is not limited to touch. Embodiments could be implemented using a mouse, stylus, or any other method of selecting a display using the custom display selection user interface.

### Frames in a Single Display

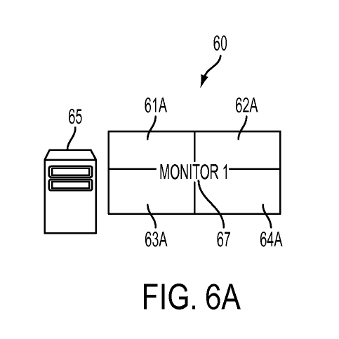

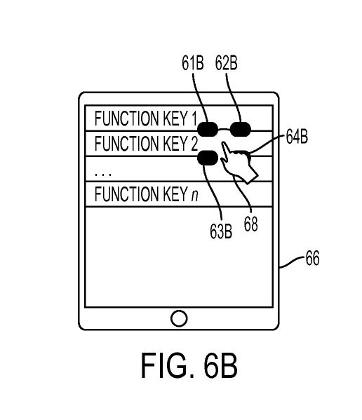

FIG. 6A shows an embodiment where the system 60 may have one display 67 which is subdivided in frames or portions 61A, 62A, 63A, 64A. In an embodiment illustrated in FIG. 6B, there may be a representation of the single display broken apart into the frames 61B, 62B, 63B, 64B on an input device 66. The frames would be oriented on the representation as they would be displayed on the display. For example, as shown in FIG. 6A where a single display is separated into four quadrant frames 61A, 62A, 63A, 64A, the frames 61B, 62B, 63B, 64B may be represented by a display layout similar to the physical location of the frames as displayed on the display. In this way, a user 68 can select a function key and a portion of the display to display.

### Multi-Device Embodiments

One or more embodiments of the disclosure may provide for sending data to a specified device without the need to preprogram a dedicated function key of a human interface device for sending to a specific device. One or more embodiments may provide for a control device, such as a server, connected to multiple connected devices.

In some embodiments, a method using a touchscreen display may be used to configure the sending of data to a specified device. However, the method of input for the embodiments is not limited to touch. Embodiments could be implemented using a mouse, stylus, or any other method of selecting a display using the custom display selection user interface.

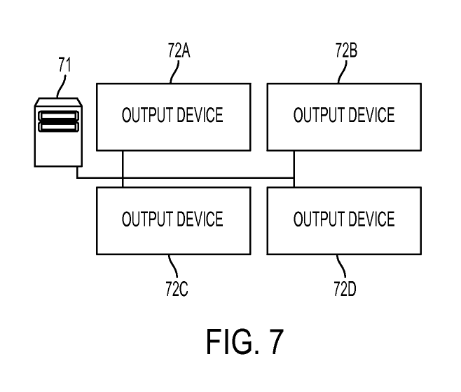

In some embodiments, the connected devices may be output devices. Non-Limiting examples of output devices include devices for printing or manufacturing and the like. In one embodiment, the output devices may include a printer, such that information can be sent to a specified printer. An exemplary embodiment of sending data to one or more output devices, based on a selected function, where one or more output device connected to the server 71 is a printing output device 72A of the output devices 72A-72D, is shown in FIG. 7. In the example, 72B-72D do not need to be printing output devices. Connected output devices may be of different types of output devices.

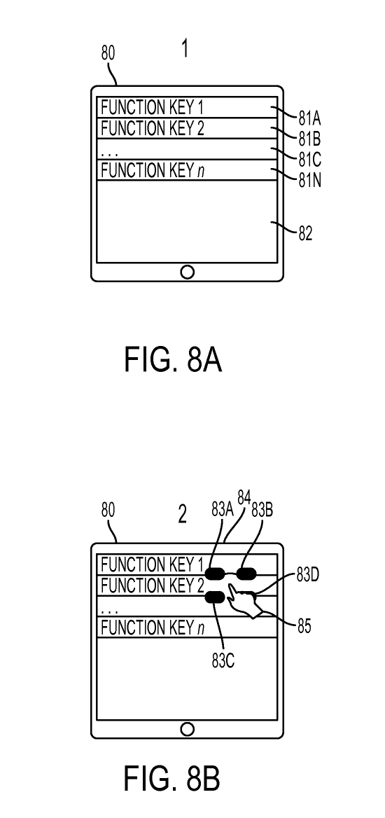

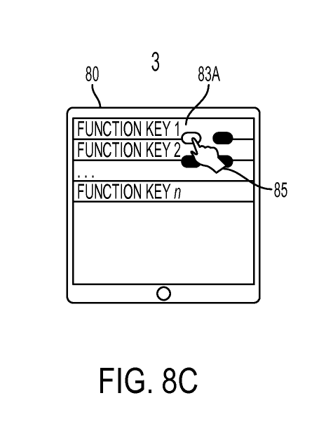

FIG. 8A shows a first menu 82 of an input device 80 where a user can perform a tap and hold gesture on the input device for a desired function key from the function keys 81A-81C, 81N. Following the tap and hold gesture, the UI on the input device then shows a representation of the output devices layout 84, as illustrated in FIG. 8B. The representation of the output devices layout 84 shows representative icons 83A-83D corresponding to the physical layout of the output devices 72A-72D. The user 85 can then drag a pointing device or pointer to the desired output device from the layout and release the hold, as shown in FIG. 8C with the exemplary selection of representative icon 83A. The input device then maps the user desired output from the representative layout, maps the function to the correct output device, and sends the function key command and desired data to the specified printer output device. In one embodiment, the input device may be directly connected to the output devices. Alternatively, the input device may be connected to the output devices through a network or the like.

The command or function may be data for manufacturing and the output device in FIG. 7 may include a manufacturing device, such as a computer numerical control (CNC) machine. Data to begin production of a product may be sent to a specified CNC machine through the UI similarly to sending to a printer output device.

One embodiment may include the sending of data from virtual machines. An embodiment may include the sending of data to a cloud or an external system or device from a device, system, or network.

An alternative output device that may be connected to the server 71 in FIG. 7 may be a storage device. A user may select a command or function so that data is sent to a specified storage device. In one embodiment, the user may tap and hold on a data file shown on a UI in order to bring up the layout of storages devices. The user could then select a storage device in order to move the data file to that storage device. In another embodiment, the UI may have a function key to execute a software program and then save the results of the program in a specified storage device.

In some embodiments, the connected devices may be servers, workstations, or virtual machines. The user may be able to send commands to implement updates or execute commands on the connected devices. The terms “connected device”, “output device”, and “storage device” used in the description is intended to describe embodiments with devices which can receive data, and are by no means restrictive.

### Representative Layouts of Devices

In some embodiments, the layout of the connected devices may be shown as perceived from an overhead view of where the devices are located. In one embodiment, the orientation of the overhead view may be oriented at least according to a cardinal direction, preprogramming, or an orientation as selected by a user. The overhead view may be preprogrammed or oriented in order to align with the floor plan of the building for the convenience of the user.

The representation of the layout of connected devices may be overlaid on a map or floor plan to indicate physical placement in a location.

Instead of an overhead view, the representation of the layout of connected devices may show relative placement of the devices to one another as perceived from a bird's eye view. A bird's-eye view being an elevated view of an object from above, with a perspective as though the observer were a bird. The perspective from which the bird's eye view is taken may be oriented at least according to a cardinal direction, preprogramming, or an orientation as selected by a user.

The UI may be used with a mobile device as part of the control system. According to an embodiment, the sensors of the mobile device may be used to provide additional functionality. The mobile device may have positional sensors, such as GPS or a gyroscope. In one embodiment, the representation of the layout of connected devices may be oriented based on the position and orientation information of the mobile device. This means the layout may be oriented depending on the orientation of the mobile device. For example, if a user holds a mobile device in a standard user position facing in one direction, the UI representation of the connected devices layout will be oriented to face in the same direction.

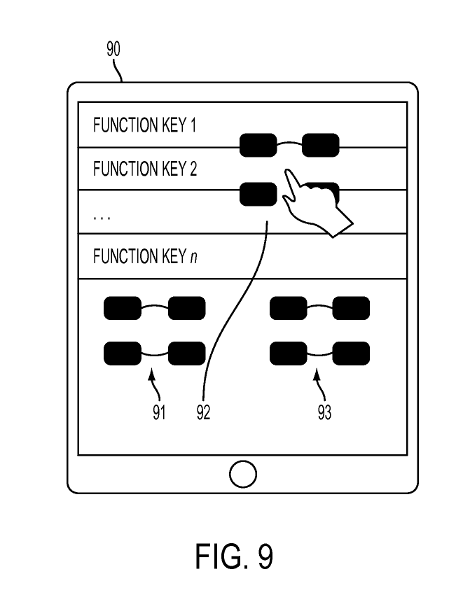

FIG. 9 illustrates a screen where groupings of devices may be provided. In some embodiments, the representation of the layout of connected devices may include groupings of displays as they are physically arranged. An example of where clusters or groupings may occur is when the control system is connected to multiple servers, each server being connected an arrangement of displays. In an exemplary embodiment of FIG. 9, there are three groupings of displays 91, 92, and 93, each grouping being a set of monitors connected to an individual server.

### Readiness of a Device

In some embodiments, the UI may indicate that a connected device is unsuitable for the user's function or command. A device may be unsuitable for various reasons. One example is where the connected device is improper for the intended function, such as displaying when the device is a storage device. One example is where a display has a resolution too low to properly display the data. Another example, where the connected devices include a printer, is where the user desires to print data that is formatted for a different paper size than a printer carries. Another example is where the user desires to print in color when a printer is black and white. One example, where the connected devices include a storage device, is where a specific storage device does not have sufficient memory to properly execute the command or function.

In some embodiments, the visibility of a representative icon may be contextually controlled so that the user to indicate that it is not usable based on the console settings or intended command. The visibility of the individual icon may be altered by means of changing the border, transparency of the elements, or the like.

The indication may include greying out the representative icon of the device, a textual notification, or the like. The indication may be paired with an auditory sound to indicate a specific device is unsuitable if the user attempts to select it.

Although this specification has been described above with respect to the exemplary embodiments, it shall be appreciated that there can be a variety of permutations and modifications of the described exemplary features by those who are ordinarily skilled in the art without departing from the technical ideas and scope of the features, which shall be defined by the appended claims.

A method of one or more exemplary embodiments may be recorded as computer-readable program codes in non-transitory computer-readable media (CD ROM, random access memory (RAM), read-only memory (ROM), floppy disks, hard disks, magneto-optical disks, and the like) including program instructions to implement various operations embodied by a computer.

While this specification contains many features, the features should not be construed as limitations on the scope of the disclosure or of the appended claims. Certain features described in the context of separate embodiments can also be implemented in combination. Conversely, various features described in the context of a single exemplary embodiment can also be implemented in multiple exemplary embodiments separately or in any suitable sub-combination.

Although the drawings describe the UI views in a specific order, one should not interpret that the UI views are performed in a specific order as shown in the drawings or successively performed in a continuous order, or all the UI views are necessary to obtain a desired result. Also, it should be noted that all embodiments do not require the distinction of various system components made in this description. The device components and systems may be generally implemented as a single software product or multiple software product packages.

A number of examples have been described above. Nevertheless, it is noted that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

There is claimed:

1. A method for sending data to a connected device in a device system having at least two connected devices, the device system having a graphical, interactive user interface with operation objects, the method comprising:
displaying the user interface on an input display;
selecting a function key from a first menu of the user interface in accordance with movement of a user, the first menu of the user interface having at least one function key;
selecting a specified connected device from a second menu of the user interface in accordance with movement of a user, the second menu of the user interface having a representative layout of the connected devices indicating relative physical placements of the connected devices; and
sending data related to the function key to the specified connected device.

2. The method of claim 1, wherein the input display is a touchscreen display.

3. The method of claim 1, further comprising:
wirelessly connecting an input device to the device system, the input device being used as the input display the user interface.

4. The method of claim 1, further comprising:
displaying at least a portion of the data sent to the specified connected device, the data being related to the function key to the specified connected device, when the specified connected device is a display.

5. The method of claim 1, further comprising:
executing a process based on the data sent to the specified connected device.

6. The method of claim 5, further comprising:
printing based on the data sent to the specified connected device where the connected device is a printer.

7. The method of claim 5, further comprising:
storing the data sent to the specified connected device where the connected device is a storage device.

8. The method of claim 1, wherein the second menu of the user interface, having a representative layout of the connected devices indicating relative physical placements of the connected devices, displays the layout as seen from an overhead view.

9. The method of claim 1, wherein the second menu of the user interface, having a representative layout of the connected devices indicating relative physical placements of the connected devices, displays the layout as seen from a bird's eye view.

10. The method of claim 1, wherein the second menu of the user interface, having a representative layout of the connected devices indicating relative physical placements of the connected devices, can be toggled and maintained on the user interface.

11. The method of claim 10, wherein the second menu, when maintained on the user interface, can transfer the data sent to the connected device to a second connected device by a swiping movement from an icon representing the connected device to an icon representing the second connected device.

12. The method of claim 1, wherein the second menu displays readiness information regarding each connected device.

13. A device system having a graphical, interactive user interface with operation objects for sending data to a connected device, the device system comprising:
an input display, the input display displaying the user interface; and
at least two connected devices;
wherein the user interface has a first menu for selecting a function key in accordance with movement of a user, the first menu of the user interface having at least one function key,
wherein after selecting a function key on the first menu of the user interface, the user interface has a second menu for selecting a specified connected device from the at least two connected devices in accordance with movement of a user, the second menu of the user interface having a representative layout of the connected devices indicating relative physical placements of the connected devices, and
wherein the device system then sends data related to the function key to the specified connected device.

14. The device system of claim 13, wherein the input device is a mobile device wirelessly connected to the device system.

15. The device system of claim 13, wherein the connected device is a display and display at least a portion of the data sent relating to the function key.
